(19) United States
(12) Patent Application Publication
(10) Pub. No.: US 2025/0353245 A1
(43) Pub. Date: Nov. 20, 2025

(54) Flatbed applicator and related method

(71) Applicant: Moditech Scandinavia AB, Karlstad (SE)

(72) Inventor: Patrik Johansson, Karlstad (SE)

(73) Assignee: Moditech Scandinavia AB, Karlstad (SE)

(21) Appl. No.: 18/868,187

(22) PCT Filed: May 21, 2023
(86) PCT No.: PCT/SE2023/050496

§ 371 Date: Nov. 22, 2024

(30) Foreign Application Priority Data
May 26, 2022 (SE) 2230164-2

(51) Int. Cl. B29C 59/04; B05C 1/02; B05C 1/08

(52) U.S. Cl. CPC B29C 59/046; B05C 1/025; B05C 1/0821

(57) ABSTRACT

Flatbed applicator having a frame (10) comprising first and second leg sections (11a, 11b) arranged at opposite longitudinal ends of the applicator (1) and at least one longitudinal beam (21, 22) extending in the longitudinal direction (L) of the applicator between the first leg section and the second leg section; a table (30) being supported by the frame and comprising a first guide rail (36a) and a second guide rail (36b) being parallel to the first guide rail (36a); and a roller support structure (50) rotatably supporting a roller (40) and comprising: a transversal beam (51) extending underneath the table; and a first guide unit (56a) supported by the first guide rail and second guide unit (56b) supported by the second guide rail. The roller support structure comprises at least one third guide unit (60) being attached to the transversal beam (51) and supported by the at least one longitudinal beam (21, 22).

The present invention relates to a flatbed applicator and a related method. In particular, the present invention relates to improve stability of a flatbed applicator.

From WO2020078646A1 there is known flatbed applicator comprising a table, a roller, and a roller support structure comprising guide members configured to be horizontally guided along the table in profiles attached underneath the table adjacent each longitudinal edge of the table.

Although the arrangement disclosed in WO2020078646A1 may be sufficiently stable to guide the support structure horizontally in many circumstances, it is generally desirable to increase the reliability and accuracy of the horizontal movement of the roller support structure. Also, it is generally desirable to accurately control vertical position of the roller and the clamping pressure of the roller, i.e. the pressure by which the roller is brought to press down onto the table or onto a workpiece positioned on the table.

An object of the present disclosure is to mitigate at least some of these problems.

Another object of the present disclosure is to provide a flatbed applicator having improve stability as compared to prior art flatbed applications.

Another object of the present disclosure is to provide a flatbed applicator, as well as a related method, which allow accurate control of horizontal and vertical movement of the roller.

Another object of the present disclosure is to provide a flatbed applicator and a related method having alternative and/or improved means for guiding the roller horizontally and vertically.

A further object of the present disclosure is to provide a flatbed applicator and a related method having alternative and/or improved means for accurately controlling and/or adjusting clamping pressure of the roller.

Yet a further object of the present disclosure is to provide a flatbed application having a table with improved horizontal alignment.

The claimed invention is specified in the appended claims.

According to a first aspect, the present disclosure provides a flatbed applicator displaying a longitudinal direction and a transversal direction being orthogonal to the longitudinal direction, the applicator comprising:
a frame comprising first and second leg sections arranged at opposite longitudinal ends of the applicator and at least one longitudinal beam extending in the longitudinal direction between the first leg section and the second leg section;
a table being supported by the frame and comprising a first guide rail and a second guide rail being parallel to the first guide rail, the guide rails extending in the longitudinal direction (L), preferably at or adjacent to longitudinal sides of the table;
a roller extending across the table in a transversal direction of the applicator; and
a roller support structure rotatably supporting the roller and comprising:
   a transversal beam extending in the transversal direction underneath the table in an area between the table and the at least one longitudinal beam; and
   a first guide unit supported by the first guide rail and second guide unit supported by the second guide rail, the first and second guide units being attached to the transversal beam and configured to guide the roller support structure in the longitudinal direction in the first and second guide rails;

wherein the roller support structure comprises at least one third guide unit being attached to the transversal beam and supported by the at least one longitudinal beam.

The table may comprise a surface which may be horizontally or substantially horizontally orientated when the flatbed applicator is in operation. The roller may be movable in a horizontal and a vertical direction across the table.

The at least one longitudinal beam provides support for the transversal beam, thus allowing vertical loads on the roller support structure to be absorbed by the at least one longitudinal beam. Consequently, by providing support for the roller support structure not only in the first and second guide rails but also in the at least one longitudinal beam, increased stability and dimensional integrity (and thus accuracy when performing applicator work, i.e. laminating work) is achieved. Also, the at least one longitudinal beam providing support for the transversal beam contributes to counteracting deflection of the table, in particular in long flatbed applicators when the roller support operates midway between the first and second leg sections. Consequently, the at least one longitudinal beam providing support for the transversal beam contributes to maintaining a horizontal alignment of the table.

The at least one third guide unit may, in the vertical direction, be arranged between or intermediate the transversal beam and the at least one least one longitudinal beam.

The at least one third guide unit may, in the transversal direction, be arranged between the first guide unit and the second guide unit.

The at least one third guide unit may be configured to interact with a substantially horizontal support surface of the at least one longitudinal beam.

The at least one third guide unit may comprise at least one guide member configured to roll or slide on said at least one support surface.

The at least one guide member may comprise a wheel having a rotational axis being parallel to a rotational shaft of the roller.

The at least one third guide unit may, in the vertical direction, be arranged in the same plane as the roller.

According to a second aspect, the present disclosure provides a method of operating the flatbed applicator according to the first aspect, wherein the method comprises guiding the roller support structure along the guide rails and along the at least one longitudinal beam during longitudinal movement of the roller.

The roller support structure may be supported by the at least one longitudinal beam during longitudinal movement of the roller.

According to a third aspect, the present disclosure provides a method of operating a flatbed applicator displaying a longitudinal direction and a transversal direction being orthogonal to the longitudinal direction, the applicator comprising:
a frame comprising first and second leg sections arranged at opposite longitudinal ends of the applicator and at least one longitudinal beam extending in the longitudinal direction between the first leg section and the second leg section;
a table being supported by the frame and comprising a first guide rail and a second guide rail being parallel to the first guide rail, the guide rails extending in the longitudinal direction, preferably at or adjacent to longitudinal sides of the table;
a roller extending across the table in a transversal direction of the applicator; and
a roller support structure rotatably supporting the roller and comprising:
   a transversal beam extending in the transversal direction underneath the table in an area between the table and the at least one longitudinal beam; and
   a first guide unit supported by the first guide rail and second guide unit supported by the second guide rail, the first and second guide units being attached to the transversal beam and configured to guide the roller support structure in the longitudinal direction in the first and second guide rails;
the method comprising guiding the roller support structure in the longitudinal direction along the first and second guide rails and, using at least one third guide unit being attached to the transversal beam, along the at least one longitudinal beam.

The above-discussed aspects may be used in any combination with each other.

Following drawings are appended to facilitate the understanding of the disclosure and the invention as it is defined in the claims.

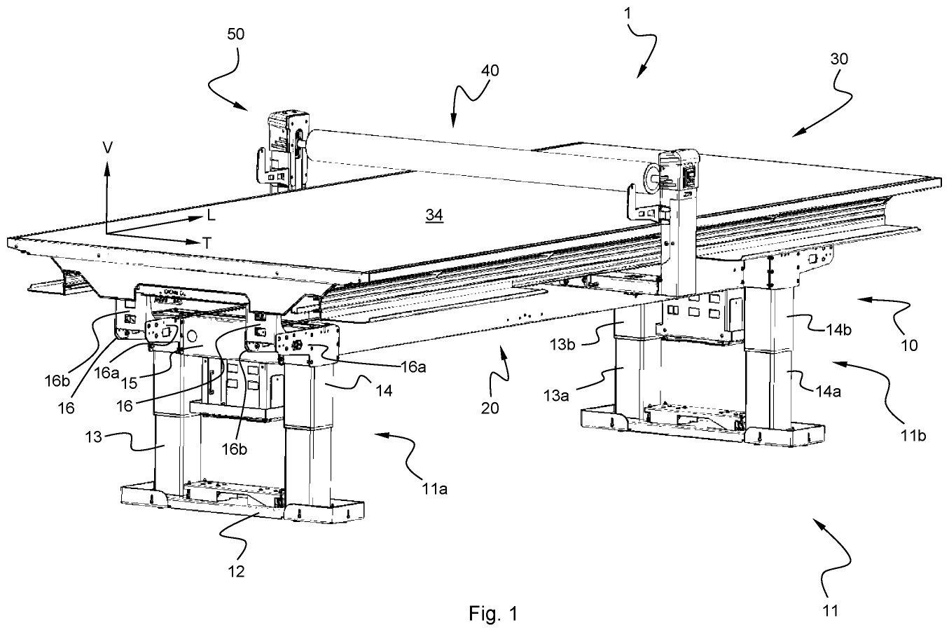

FIG. 1 shows a perspective view of a flatbed applicator according to an embodiment of the disclosure.

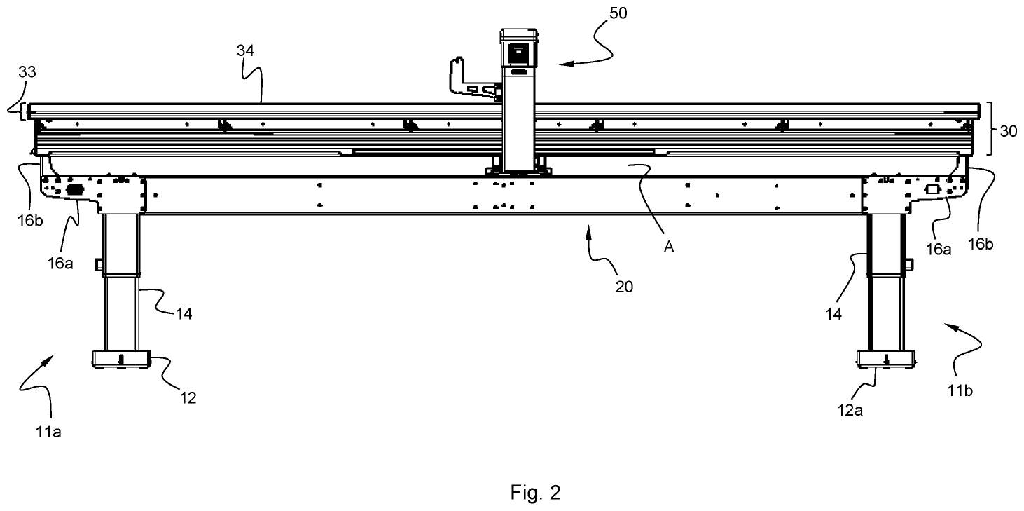

FIG. 2 is a side view of the flatbed applicator according to FIG. 1.

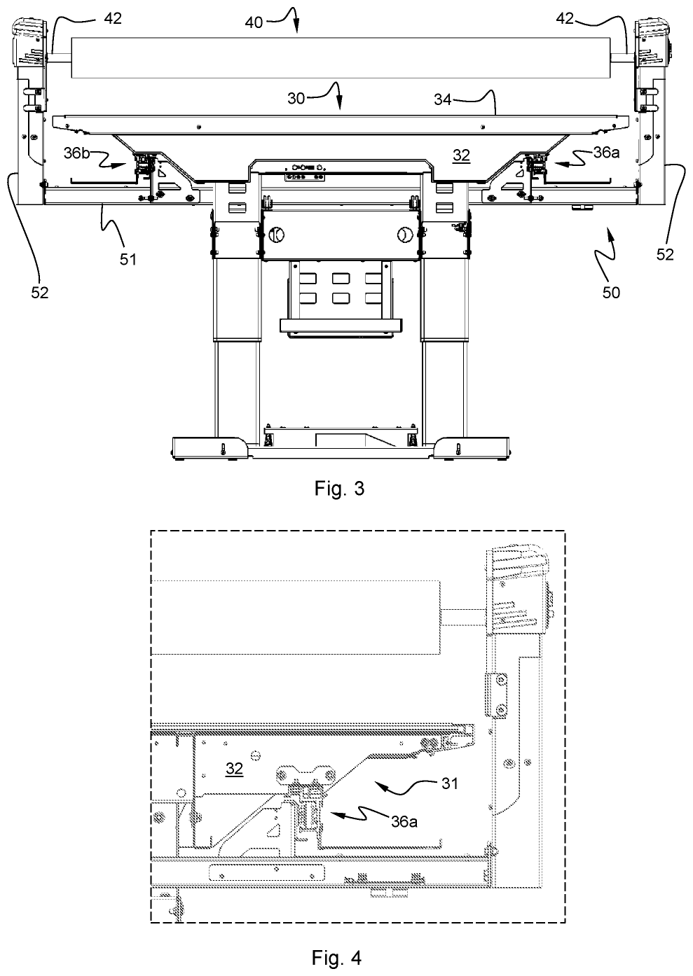

FIG. 3 is an end view of the flatbed applicator according to FIG. 1.

FIG. 4 is detailed end view of the flatbed applicator according to FIG. 1.

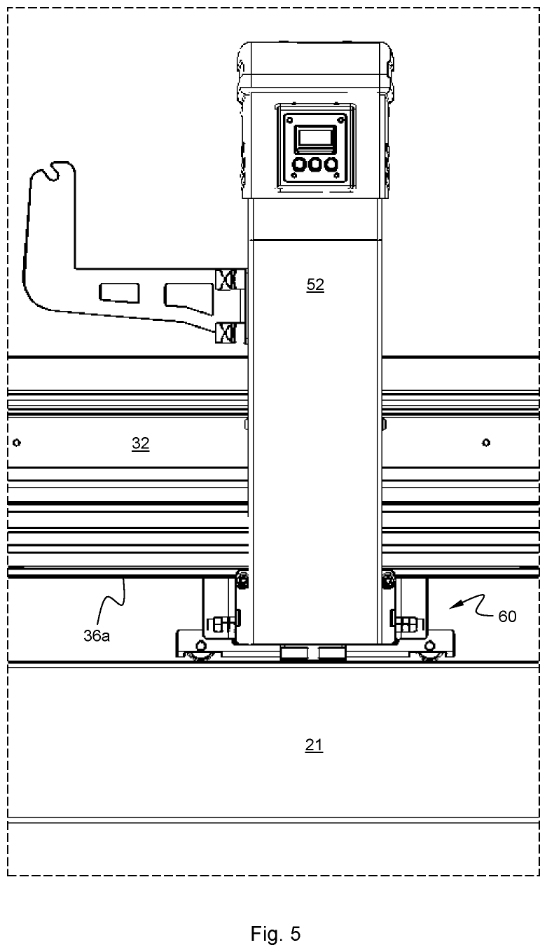

FIG. 5 is detailed side view of the flatbed applicator according to FIG. 1.

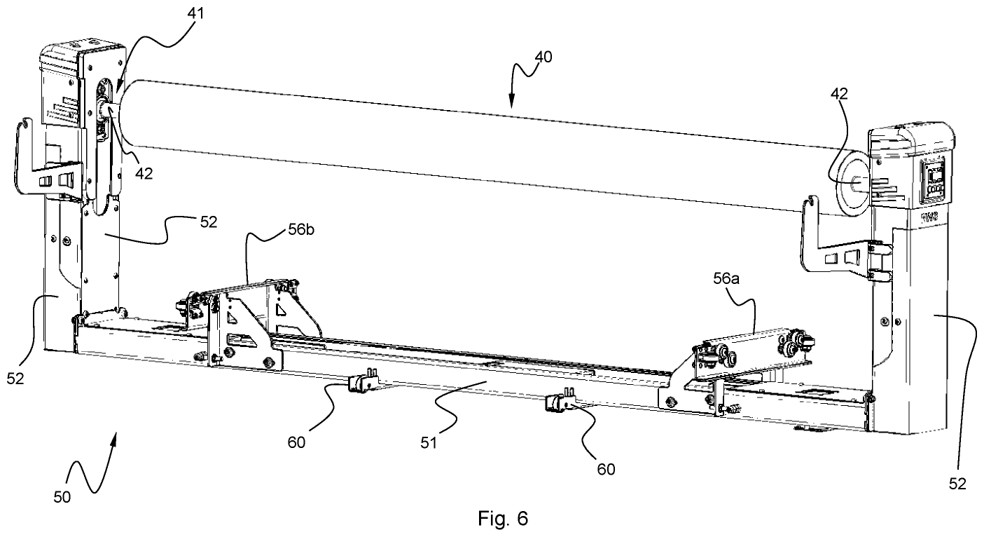

FIG. 6 shows a perspective view of a roller and a roller support structure of the flatbed applicator according to FIG. 1.

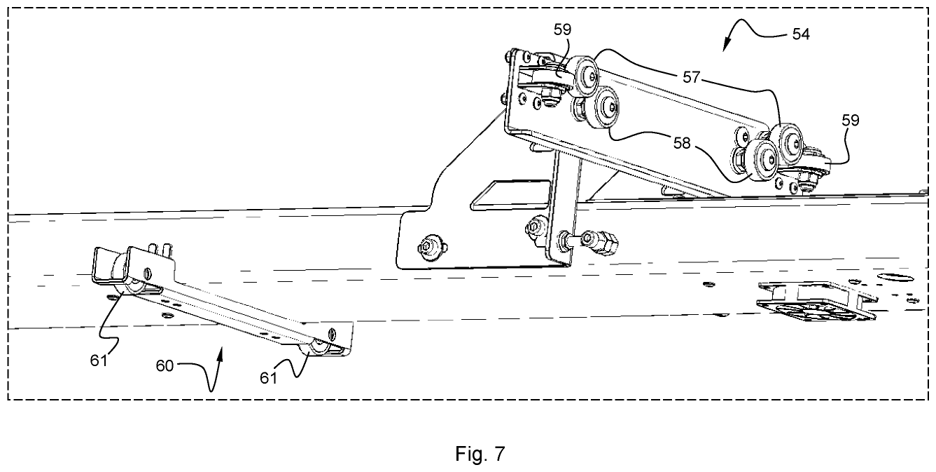

FIG. 7 is detailed perspective view of the roller support structure according to FIG. 6.

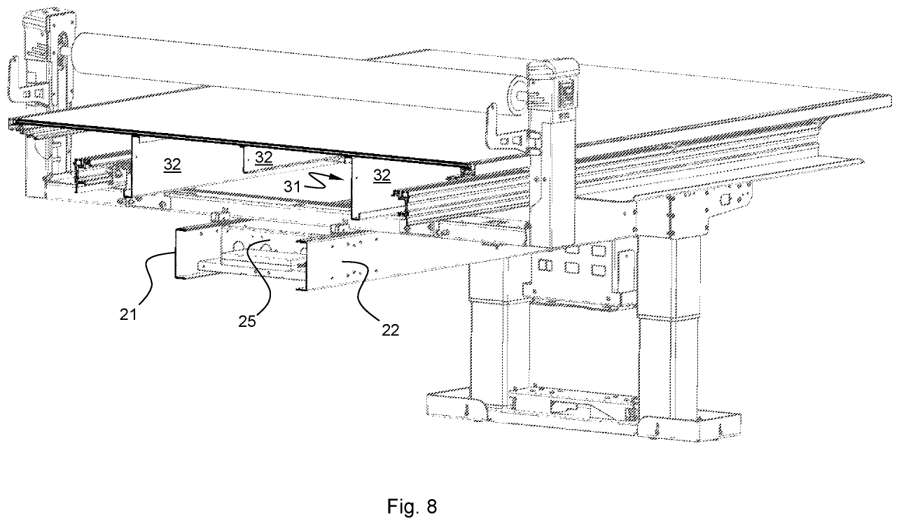

FIG. 8 shows a perspective cross-sectional view of the flatbed applicator according to FIG. 1.

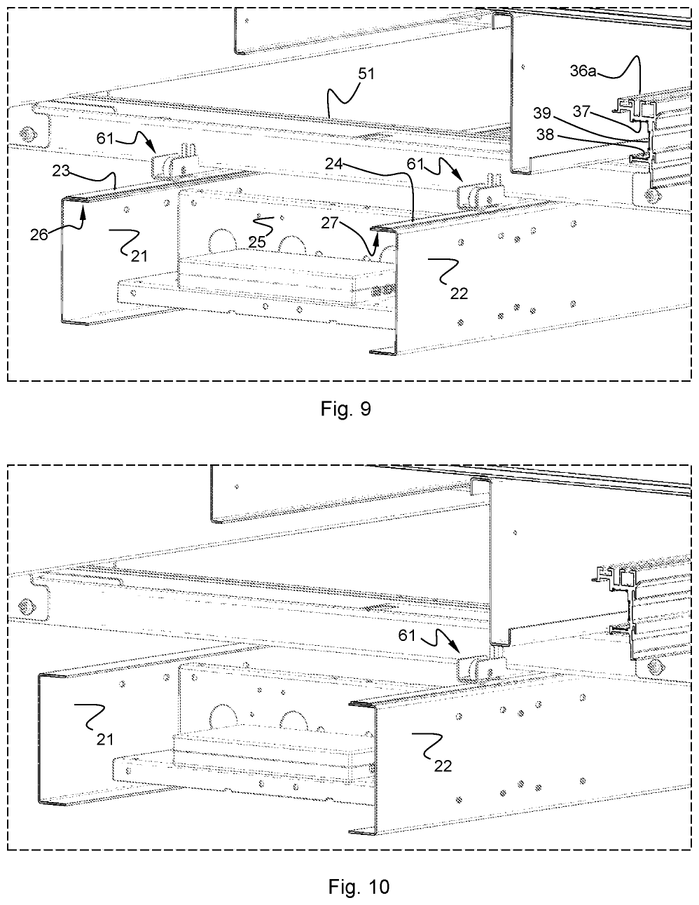

FIG. 9 is detailed perspective cross-sectional view of the flatbed applicator according to FIG. 8.

FIG. 10 is detailed perspective cross-sectional view of a flatbed applicator according to a further embodiment of the disclosure.

In the drawings, like reference numerals are used to indicate common parts, elements or features unless otherwise explicitly stated or implicitly understood from the context.

FIGS. 1 shows an embodiment of flatbed applicator 1 comprising a frame 10, a table 30, a roller 40 and a roller support structure 50 configured to guide the roller 40 vertically and horizontally across the table 30.

The applicator 1 has a longitudinal L, a transversal T and a vertical V axis defining a longitudinal, a transversal and a vertical extent or direction, respectively, of the applicator 1. The longitudinal L, transversal T and vertical V axes are orthogonal. When the applicator 1 is in operation, the applicator 1 is typically orientated such that the longitudinal L and transversal T axes are arranged in the horizontal plane.

The frame 10 comprises a leg arrangement 11 including a first leg section 11a arranged at a first longitudinal end of the applicator 1 and a second leg section 11b arranged at a second longitudinal end of the applicator 1. Each leg section 11a, 11b comprises a footplate 12. Each leg section 11a, 11b also comprises first 13 and second 14 leg columns which are attached to and extend in the vertical direction V from the footplate 12. Each leg section 11a, 11b further comprises a transversal beam 15 which is attached to and extend in the transversal direction T between the upper terminus of the leg columns 13, 14. Each leg section 11a, 11b further comprises substantially longitudinal frame members 16a which are attached to the upper terminus of the leg columns 13, 14 and extend, in the longitudinal direction L, away from from the leg columns 13, 14. Each leg section 11a, 11b also comprises substantially vertical frame members 16b which are attached to distal ends of the frame members 16a and extend, in the vertical V direction, up from the frame members 16a. The table 30 is supported by the vertical frame members 16b such that the table 30, at each longitudinal end, is supported by the frame 10 in a plane above the upper terminus of the leg columns 13, 14. (e.g. see FIG. 2).

The frame 10 further comprises a longitudinal frame section 20 which is attached to and extend in the longitudinal direction L between the first and second leg sections 11a, 11b. In the present embodiment, the frame section 20 is substantially level with the frame members 16a. Thus, the frame 10 provides an area A below the table 30 and between the frame members 16b that is free from frame structures (e.g. see FIG. 2).

The longitudinal frame section 20 comprises at least one longitudinal beam which is attached to and extend in the longitudinal direction L of the applicator 1. In the present embodiment, the longitudinal frame section 20 comprises first and second longitudinal and parallel beams 21, 22 which are attached to and extend between the upper terminus of leg columns 13 and 14, respectively (e.g. see FIGS. 8 and 9). Each longitudinal beam 21, 22 comprises a planar support surface 23, 24 which extends in the longitudinal direction L (e.g. see FIG. 9). In the present embodiment, the longitudinal frame section 20 also comprises transversal beams 25 which are attached to and extend between the longitudinal beams 21, 22 in the transversal direction T of the applicator 1.

The leg columns 13, 14 may be vertically adjustable, e.g. telescopically adjustable, thus allowing the height of the table 30 to be adjusted in the vertical direction V. In the present embodiment, each leg column 13, 14 comprises a first, lower leg column section 13a, 14a and a second, upper leg column section 13b, 14b, wherein the second leg column section 13b, 14b is arranged telescopically slidable outside of the first leg column section 13a, 14a (e.g. see FIG. 1).

The footplates 12 may comprise retractable wheels (not disclosed) which may be extended below a lower support surface 12a of the footplates 12 to allow easy horizontal repositioning of the applicator 1 (e.g. see FIG. 2).

The table 30 comprises a table frame structure 31 including longitudinal and transversal frame beams 32 (e.g. see FIGS. 4-5 and 8) forming a table framework. The table 30 also comprises a tabletop 33 displaying a substantially planar top or working surface 34 which is substantially right-rectangular (e.g. see FIGS. 1 and 2). When the applicator 1 is in operation, the working surface 34 is typically horizontally orientated. The working surface 34 may be at least partially translucent and the tabletop 33 may be provided with lights (not shown) allowing a workpiece positioned on the working surface 34 to be backlit.

The table 30 further comprises first and second longitudinal and parallel guide rails 36a, 36b extending in the longitudinal direction L of the applicator 1 and being arranged at or adjacent each longitudinal side of the table 30 (e.g. see FIGS. 3, 4 and 9). The guide rails 36a, 36b are attached to the table frame structure 31 underneath the table 30. The guide rails 36a, 36b may typically comprise extruded metal profiles, e.g. aluminium profiles.

The roller support structure 50 comprises a first section 51 forming a substantially rectilinear beam extending in the transversal direction T under the table 30 (e.g. see FIGS. 3 and 6). The beam 51 extends beyond of the longitudinal sides of the table 30 (e.g. see FIG. 3). The roller support structure 50 also comprises second sections 52 which are fixedly connected to and extend substantially vertically upwards from the respective end of the beam 51 to a level which is above the plane of the working surface 34. Consequently, the second sections 52 form post members of the support structure 50 extending above the working surface 34 on either longitudinal side of the table 30.

The roller 40 comprises a shaft 41 having shaft pins 42 allowing the roller support structure 50 to rotatably carry the roller 40 in the post members 52 (e.g. see FIG. 6). To this end, each post member 52 comprises a shuttle (not shown) rotatably supporting the shaft pins 42 and allowing the roller 40 to travel vertically in the post members 52, i.e. in the vertical direction V of the applicator 1. Each post member 52 comprises an actuating arrangement (not shown) for actuating the shuttle (and thus the roller 40 rotatably supported by the shuttles) between a first, raised position, in which the roller 40 is raised above the working surface 34, and a second, lowered position, in which the roller 40 is in direct or indirect contact with the working surface 34, e.g. clamping a working piece positioned between the roller 40 and the working table 34. Such shuttles and actuating means are known as such and will not be discussed in any more detail here. However, they may typically comprise electric or pneumatic actuating means and may typically comprise means for controlling the clamping pressure between the roller 40 and the working table 34 (or between the roller and a working piece positioned on the table).

The roller support structure 50 further comprises guide units arranged to allow the roller support structure 50 (and thus also the roller 40) to travel linearly in the longitudinal direction L of the applicator 1 (e.g. see FIG. 6).

The guide units comprise a first guide unit 56a and a second guide unit 56b which are attached to the transversal beam 51 and configured to be guided in the longitudinal direction L along the first and second guide rails 36a, 36b, respectively. The first and second guide units 56a, 56b may be arranged to roll or slide roll along the first and second guide rails 36a and 36b, respectively. In the present embodiment, each guide unit 56a, 56b comprises a first set of guide members 57 (see FIG. 7) configured to interact with a horizontal, downwardly facing support surface 37 of the guide rail 36a, 36b (see FIG. 9), a second set of guide members 58 configured to interact with a horizontal, upwardly facing support surface 38 of the guide rail 36a, 36b, and a third set of guide members 59 configured to interact with a vertical support surface 39 of the guide rail 36a, 36b. Interaction between the guide members 57, 58, 59 and the support surfaces 37-38 allow the guide unit 56a, 56b to travel in the longitudinal direction D but prevents the guide unit 56a, 56b from moving in the transversal direction T and the vertical direction V. In the present embodiment, the guide members are wheels. In other embodiments, however, the guide members may be slides or a combination of slides and wheels.

The guide units also comprise a pair of third guide units 60. The third guide units 60 are attached to the transversal beam 51 and configured to be guided in the longitudinal direction L along the longitudinal beams 21 and 22, respectively. The third guide units 60 are supported by the longitudinal beams 21, 22. Consequently, the longitudinal beams 21, 22 will share the load of the roller support structure 50, thus relieving the guide rails 36a, 36b and the table 30 from a corresponding load and preventing table deflection, in particular when the roller support structure 50 is operated midway between the leg sections 11a, 11b. Consequently, the longitudinal beams 21, 22 and the third guide units 60 contribute to maintaining the working surface 34 substantially horizontal during operation of the applicator 1.

In the present embodiment, each third guide unit 60 comprises guide members 61 configured to interact with the horizontal, upwardly facing support surface 23, 24 of the longitudinal beams 21, 22 (e.g. see FIGS. 7 and 9), thus allowing the longitudinal beams 21, 22 to take load in the vertical downward direction. In other embodiments, the third guide units 60 may additionally or alternatively comprise guide members (not shown) configured to interact with a horizontal, downwardly facing support surface 26, 27 of each longitudinal beam 21, 22 (see FIG. 9), thus allowing the longitudinal beams 21, 22 to take load also or alternatively in the vertical upward direction. In some applications such a configuration may be advantageous to at least partially relieve the guide rails 36a, 36b from clamping forces, i.e. forces that arise when the roller 40 is clamped to the table 30 or to a workpiece positioned on the table 30.

The longitudinal beams 21, 22 may comprise metal strips providing said support surfaces 23, 24, 26, 27.

In the present embodiment, the guide members 61 are wheels. In other embodiments, however, the guide members 61 may be slides or a combination of slides and wheels.

In the present embodiment, each third guide unit 60 comprises a carriage or cradle arranged between the transversal beam 51 and the longitudinal beam 21, 22, in which carriage or cradle the transversal beam 51 is resting. It is to be understood, however, that other configurations may equally well be employed as long as the configuration is capable of transmitting load between the transversal beam 51 and the longitudinal beam 21, 22.

As is known in the art, longitudinal movement of the roller 40 and roller support structure 50 across the table 30 may be realised by an operator manually pushing or pulling the roller and roller support structure across the table. Alternatively, longitudinal actuation of the roller 40 and roller support structure 50 may be realised using any suitable motor arrangement known in the art, preferably comprising an electric motor. Different types of such motor arrangements are known in the art and will not be discussed further here.

The longitudinal beams 21 and 22 and the guide rails 36 provide support during longitudinal movement of the roller support structure 50 and also allow vertical loads on the roller support structure 50 to be absorbed by the longitudinal beams 21 and 22. Thus, by providing support for the roller support structure 50 not only in the guide rails 36a, 36b but also in the longitudinal beams 21 and 22, increased stability and dimensional integrity (and thus accuracy when performing applicator work, i.e. laminating work) is achieved.

It may be advantageous that the transversal beam 51 is supported by both longitudinal beams 21 and 22, as is disclosed in FIG. 9 and discussed above. However, in some applications it may be preferred that the transversal beam 51 is supported by only one of the longitudinal beams, e.g. as is disclosed in FIG. 10, in which disclosed embodiment the transversal beam 51 is supported by longitudinal beam 22 but not by longitudinal beam 21. In some embodiments (not disclosed) the longitudinal frame section extending between the first and second leg sections may comprise more than two longitudinal beams, in which case it may be advantageous that the transversal beam 51 is supported by more than two longitudinal beams extending between the first and second leg sections. In some embodiments (not disclosed) the longitudinal frame section extending between the first and second leg sections may comprise a longitudinal beam which is centrally positioned, i.e. positioned midway between the longitudinal sides of the table, which centrally positioned longitudinal beam provides support for the transversal beam 51.

In the preceding description, various aspects of a flatbed applicator have been described with reference to the illustrative drawings. For purposes of explanation, specific numbers, systems, and configurations were set forth in order to provide a thorough understanding of the flatbed applicator and its workings. However, this description is not intended to be construed in a limiting sense. Various modifications and variations of the illustrative embodiment, as well as other embodiments of the apparatus, which are apparent to person skilled in the art to which the disclosed subject-matter pertains, may lie within the scope of the present invention as defined by the following claims.

1. A flatbed applicator displaying a longitudinal direction and a transversal direction being orthogonal to the longitudinal direction, the applicator comprising:
a frame comprising first and second leg sections arranged at opposite longitudinal ends of the applicator and at least one longitudinal beam extending in the longitudinal direction between the first leg section and the second leg section;
a table being supported by the frame and comprising a first guide rail and a second guide rail being parallel to the first guide rail, the guide rails extending in the longitudinal direction;
a roller extending across the table in a transversal direction of the applicator; and
a roller support structure rotatably supporting the roller and comprising:
a transversal beam extending in the transversal direction underneath the table in an area between the table and the at least one longitudinal beam; and
a first guide unit supported by the first guide rail and second guide unit supported by the second guide rail, the first and second guide units being attached to the transversal beam and configured to guide the roller support structure in the longitudinal direction in the first and second guide rails;
wherein the roller support structure comprises at least one third guide unit being attached to the transversal beam and supported by the at least one longitudinal beam.

2. The flatbed applicator according to claim 1, wherein the at least one third guide unit, in the vertical direction, being arranged between the transversal beam and the at least one least one longitudinal beam.

3. The flatbed applicator according to any one of claim 1 or 2, wherein the at least one third guide unit, in the transversal direction, is arranged between the first guide unit and the second guide unit.

4. The flatbed applicator according to claim 1, wherein the at least one third guide unit is configured to interact with a substantially horizontal support surface of the at least one longitudinal beam.

5. The flatbed applicator according to claim 4, wherein the at least one third guide unit comprises at least one guide member configured to roll or slide on said at least one support surface.

6. The flatbed applicator according to claim 5, wherein the at least one guide member comprises a wheel having a rotational axis being parallel to a rotational shaft of the roller.

7. The flatbed applicator according to claim 1, wherein the at least one third guide unit, in the vertical direction, is arranged in the same plane as the roller.

8. A method of operating the flatbed applicator according to claim 1, comprising guiding the roller support structure along the guide rails and along the at least one longitudinal beam during longitudinal movement of the roller.

9. The method according to claim 8, wherein the roller support structure is supported by the at least one longitudinal beam during longitudinal movement of the roller.
